(19) United States
(12) Patent Application Publication
(10) Pub. No.: US 2004/0236132 A1
(43) Pub. Date: Nov. 25, 2004

(54) Method for manufacturing dicyclic phosphorus melamine compounds having superior fire retardancy and fire retardant material using thereof

(76) Inventors: Dae Hee Lee, Chengju-City (KR); Dong Ho Hyun, Cheongju-City (KR); Su Han Gwon, Cheongju-City (KR); Hyun Deok Cho, Cheongju-City (KR); Sang Bum Kim, Seoul (KR)

Correspondence Address: RALPH W. SELITTO, JR., C/O MCCARTER & ENGLISH, LLP, GATEWAY CENTER FOUR, 100 MULBERRY STREET, NEWARK, NJ, 07102, US

(21) Appl. No.: 10/483,272

(22) PCT Filed: Jul. 11, 2002
(86) PCT No.: PCT/KR02/01308

(30) Foreign Application Priority Data
Jul. 11, 2001 (KR) 2001-41440

(51) Int. Cl. C07F 9/02

(52) U.S. Cl. 558/83

(57) ABSTRACT

Disclosed is a method of preparing a dicyclic phosphorus-melamine compound and a flame retardant for use with a polymer using the same, in which melamine or a melamine derivative is incorporated into a dicyclic phosphorus compound via substitution, whereby the dicyclic phosphorus-melamine compound for actualizing a non-halogen flame retardant is obtained and is advantageous due to its water-insolubility and enhanced impact strenght and tensile strength after treatment due to increased dispersibility, thus having various applications. The method consists of reacting pentaerythritol with phosphorus oxychloride, to synthesize pentaerythritol ester of phosphoro chloridic acid, which is then dissolved in water, to substitute the OH group for the CI group in the ester, followed by the substituted ester with melamine or melamine derivative, to prepare the dicyclic phosphorus-melamine compound.

### TECHNICAL FIELD

The present invention relates to a preparation method of a dicyclic phosphorus-melamine compound having excellent flame retardancy, and a flame retardant for use with a polymer using the same, characterized in that melamine or a melamine derivative is incorporated into a dicyclic phosphorus compound having high phosphorus content via substitution, to give a dicyclic phosphorus-melamine compound for actualizing a non-halogen flame retardant, which can be variously applied by overcoming the disadvantage of water-solubility as well as by enhancing impact strength and tensile strength after treatment due to increased dispersibility.

### PRIOR ART

In general, as conventional flame retardants applied for increasing fire resistance of polymers, Br-based flame retardants consisting essentially of halogens have been mainly used. But, according to reinforced restrictions for environmental protection, there has been increasing an importance of non-halogen flame retardant materials that are environmentally safe, and various researches on such materials have been performed. The non-halogen flame retardants, exemplified by phosphorus-, nitrogen- and metal-based compounds, are however disadvantageous in that they are inferior in flame resistance and should be used in large amounts, or have poor processability and are limited in their application.

Thus, in order to overcome the above problems, there is required a novel halogen-free composition, and a variety of applied products are developed. Moreover, in the case of the phosphorus-based compounds, since they have the disadvantages of mold deposit and migration and are difficult to use as a flame retardant, there are attempted various methods including use of a polymerized form or addition of a specific substitutent.

In this regard, U.S. Pat. No. 3,141,032 discloses a method of preparing a cyclic phosphorus compound having high compatibility with polymers and superior flame retardancy, which can be used as a flame retardant, comprising the step of reacting a pentaerythrityl compound with a phosphorus based compound. But the above method cannot be effectively applied to various polymers and is limited in its use.

In U.S. Pat. No. 4,154,721, there is disclosed a flame retardant composition containing a pentaerythritol diphosphonate and a halogenated organic compound having at least about 30% halogen, considering ineffectiveness of independent use of pentaerythritol diphosphonate. However, thusly prepared composition cannot be considered as a halogen-free material.

In U.S. Pat. No. 4,174,343, there is disclosed a flame retardant polyolefin composition containing a combination of pentaerythrityl diphosphonate and ammonium polyphosphate, because diphosphonate cannot be used alone as a flame retardant for use with polyolefins.

In U.S. Pat. No. 4,257,931, there is disclosed a method of providing flame retarding property to poly(1,4-butylene terephthalate) polymer using a combination of pentaerythrityl diphosphonate and melamine pyrophosphate, exhibiting excellent flame resistance. But most cyclic phosphorus compounds are water-soluble, or are easily hydrolyzed, and thus are limited in their use. Further, compounds having functional groups of alkyl of at least 8 carbon atoms are drastically decreased in fire resistance, and in particular, suffer from low impact strength and tensile strength after processing due to inferior dispersibility, thus being limited in use.

### DISCLOSURE OF THE INVENTION

The present inventors have been trying to overcome disadvantages in conventional flame retardants and to synthesize novel flame retardant materials, effectively usable with all polymers.

Therefore, it is an object of the present invention to provide a method of preparing a dicyclic phosphorus-melamine compound for actualizing a non-halogen flame retardant, which is water-insoluble and is enhanced in impact strength and tensile strength after processing due to increase of dispersiblity, by incorporating a novel substituent to the dicyclic phosphorus compound via substitution.

It is another object of the present invention to provide a flame retardant of polymer using the above method.

In accordance with an embodiment of the present invention, there is provided a method of preparing a dicyclic phosphorus-melamine compound comprising the steps of: reacting pentaerytliritol with phosphorus oxychloride, to synthesize pentaerythritol ester of phosphoro chloridic acid; and dissolving the synthesized pentaerythritol ester of phosphoro chloridic acid in water to substitute the OH group for the Cl group in the ester, followed by reacting the substituted compound with melamine or a melamine derivative, to produce dicyclic phosphorus-melamine compound.

### BEST MODES FOR CARRYING OUT THE INVENTION

Based on the present invention, a new substituent is incorporated into a dicyclic phosphorus compound having a high phosphorus content through substitution, thereby realizing a non-halogen flame retardant composition, which is increased in dispersibility and is poorly water-soluble. As such, the substituent uses nitrogen-based compounds having synergistic effect in combination with the dicyclic phosphorus compound.

As for such nitrogen-based compounds, melamine derivatives are selected. Even though there exists at least one to three NH₂ groups in the melamine structure, substitution can be performed and various melamine derivatives can be incorporated to the main compound. On the other hand, phosphorus oxychloride (POCl₃) is reacted with pentaerythritol, to synthesize pentaerythritol ester of phosphoro chloridic acid. Thusly synthesized dicyclic phosphorus-melamine compound is very poorly soluble in water, and is excellent in not only compatibility with polymer but also flame retardancy. The above compound is applicable to all the polymers and can exhibit superior performance in combination with other flame retardant compositions.

The dicyclic phosphorus-melamine compound as a white powder is insoluble in water or organic solvents at room temperature, with a decomposition temperature of about 300° C. Therefore, this compound is favorable in application to polymers, and the substituted melamine has excellent flame retardancy, thus exhibiting a large synergistic effect.

The dicyclic phosphorus-melamine compound of the present invention is synthesized by reacting pentaerytiritol ester of phosphoro chloridic acid with melamine. As such, pentaerythritol ester of phosphoro chloridic acid is obtained by reaction of phosphorus oxychloride and pentaerythritol.

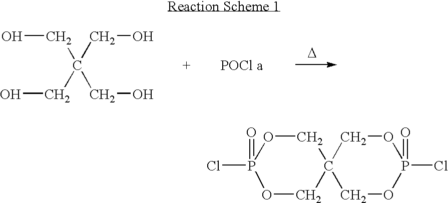

As seen in the above Reaction Scheme 1, 2-90 mol of phosphorus oxychloride (POCl₃) is added with 1 mol of pentaerythritol, heated at 10-190° C. for 1-10 hours, filtered, washed and dried. This procedure may be performed in the presence of a solvent, such as dioxane or methylene chloride. The synthesized pentaerythritol ester of phosphoro chloridic acid is a white powder and has a melting point of 246-248° C.

As for dicyclic phosphorus-melamine compound, pentaerythritol ester of phosphoro chloridic acid synthesized above is dissolved in water, and the Cl group therein is substituted with the OH group, followed by reacting the substituted ester with melamine or mealimine derivative, as seen in the following Reaction Scheme 2:

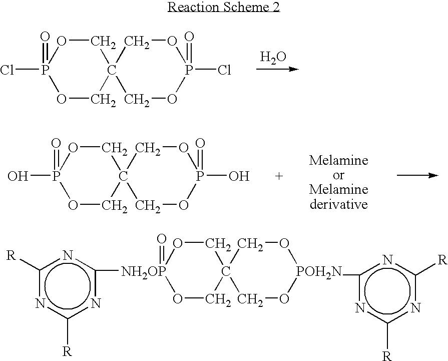

In the above Reaction Scheme 2, R represents NH₂, methyl, ethyl, phenyl, carboxymethyl, 2-carboxyethyl, cyanomethyl, and 2-cyanoethyl, or may use the following melamine derivatives.

Further, the melamine derivative usable as R in the above Reaction Scheme 2 is exemplified by methylene dimelamine, ethylene dimelamine, trimethylene dimelamine, tetramethylene dimelamine, hexamethylene dimelamine, decamethylene dimelamine, dodecamethylene dimelamine, 1,3-cyclohexylene dimelamine, p-phenylene dimelamine, p-xylylene dimelamine, 4,4-dityrene dimelamine, diethylene trimelamine, triethylene tetramelamine, tetraethylene pentamelamine, and hexaethylene heptamelamine.

As such, the above reaction may be carried out in water or other organic solvents at 10-190° C. After completion of the reaction, the product as white powders can be obtained by distillation or filtering. Thusly prepared dicyclic phosphorus-melamine compound is very useful as a flame-retardant of polymers, in which the usable polymers comprise polystyrene, polyethylene, terephthalate, polybutylene terephthalate, polypropylene, polyisobutylene, EPDM polymer, polyisoprene, ABS polymer, MBS polymer poly(acrylate), poly(methylmethacrylate), poly(vinylacetate), and polyvinyl chloride.

In addition, the phosphorus-based flame retardant, which can be used with the flame retardant of the present invention, is exemplified by triphenyl phosphate and trialkylphenyl phosphate, tricrecylphosphate, propylated triphenylphosphate, butylated triphenyl phosphate, triethylphosphate, tributylphosphate, resorcinol diphosphate, bisphenol diphosphate, dimethylmethylphosphate, polyphosphate ester, oligomeric organophosphate, ethylpyrocatechol phosphate, dipyrocatechol biphosphate, polyethylene ethyleneoxy phosphate, methylneopentyl phosphate, pentaerythritol diethylphosphate, pentaerythritol diphenylphosphate, methylneopentylphosphonate, dicyclopentyldiphosphate, and dineopentylbiphospate.

In the present invention, inorganic oxides or hydroxides or other metal compounds may be further included.

Having generally described this invention, a further understanding can be obtained by reference to certain specific examples which are provided herein for purposes of illustration only and are not intended to be limiting unless otherwise specified.

### EXAMPLE 1

### Synthesis of Dicyclic Phosphorus-Melamine Compound

To a 500 ml four-neck flask equipped with a stirrer, a cooling condensers and a thermometer, 70 g of pentaerythritol and 250 ml of phosphorus oxychloride were added, after which the temperature was gradually raised to 105° C. The generated hydrogen chloride was subjected to water substitution through a tube, with stirring for about 2 hours. After completion of the reaction, the reaction solution was allowed to stand to reach room temperature, filtered, washed 2-3 times with methylene chloride, and dried in an oven to give pentaerythritol ester of phosphoro chloridic acid as a white crystal having a melting point of 246-248° C.

Thusly obtained pentaerythritol ester of phosphoro chloridic acid (1 mol) was dissolved in 1000 ml of water, to which 2 mol of melamine was added, and heated to 100° C. The reaction mixture was stirred for 3 hours, and then filtered and dried, to synthesize dicyclic phosphorus-melamine compound.

Test for Flame Retardancy

Polypropylene homopolymer, first antioxidant: 500 ppm, second antioxidant: 1000 ppm) was kneaded with the dicyclic phosphorus-melamine compound synthesized above at 200° C., and pelletized in a twin-screw extruder, to make a test sample. Flame retardancy was measured in accordance with UL-94 protocol (Underwriters Laboratories Incorporation) and oxygen index in accordance with ASTM D2863. The results are shown in Table 1, below.

TABLE 1
Flame Retardancy Test using
Dicyclic Phosphorus-Melamine Compound

| Test | 1 | 2 | 3 |
|---|---|---|---|
| Polypropylene(*)(polymer) | 100 | 100 | 100 |
| Dicyclic Phosphorus-Melamine | 40 | 30 | 20 |
| (Flame Retardant) | | | |
| Oxygen Index | 30.2 | 29.4 | 26.5 |
| UL-94 Rating | V-0 | V-0 | V-0 |
| Drip | NO | NO | NO |

(*)polypropylene (homopolymer, first antioxidant Irganox 1010: 500 ppm, second antioxidant Irgafos 168: 1000 ppm)

### INDUSTRIAL APPLICABILITY

According to the present invention, pentaerythritol ester based cyclic compound having excellent flame resistance and good dispersibility, among phosphorus based flame retardants useful as non-halogen flame retardants, is synthesized with a melamine compound used as non-halogen flame retardant, whereby thusly synthesized compound functions as a superior flame retardant for use with various polymers. In addition, water-solubility, which is the disadvantage of conventional phosphorus- and melamine-based compounds, is overcome, and thus the inventive compound is hardly dissolved in water and also increased in dispersiblity and compatibility, thereby being designed to have superior physical properties and serving as an excellent flame retardant for use with the polymers. Further, the inventive compound is applicable to the fields of paper preparations and wood or fibers, in addition to polymers.

The present invention has been described in an illustrative manner, and it is to be understood that the terminology used is intended to be in the nature of description rather than of limitation. Many modifications and variations of the present invention are possible in light of the above teachings. Therefore, it is to be understood that within the scope of the appended claims, the invention may be practiced otherwise than as specifically described.

1. A method of preparing a dicyclic phosphorus-melamine compound having excellent flame retardancy, comprising the following steps of:
reacting pentaerythritol with phosphorus oxychloride, to synthesize pentaerythritol ester of phosphoro chloridic acid, as represented by the following Reaction Scheme 1: 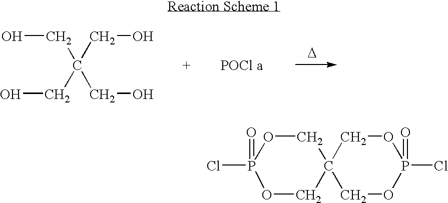
; and
dissolving the synthesized pentaerythritol ester of phosphoro chloridic acid in water to substitute the OH group for the Cl group in the ester, followed by reacting the substituted ester with melamine or melamine derivative, to prepare a dicyclic phosphorus-melamine compound, as represented by the following Reaction Scheme 2:

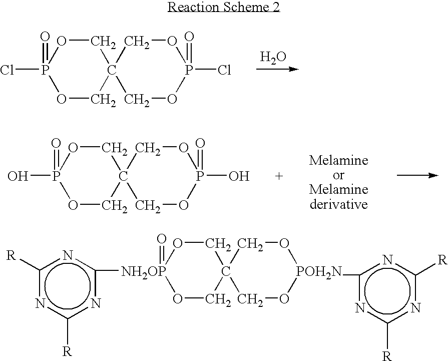

2. The method as defined in claim 1, wherein the reaction represented by the Reaction Scheme 1 is carried out by adding 1 mol of pentaerythritol to 2-90 mol of phosphorus oxychloride and heating the solution at 10-190° C. for 1-10 hours.

3. The method as defined in claim 1 or 2, wherein the reaction represented by the Reaction Scheme 1 is performed in the presence of dioxane solvent or methylene chloride solvent.

4. The method as defined in claim 1, wherein the melamine derivative used in the above Reaction Scheme 2 is selected from the group consisting of methylene dimelamine, ethylene dimelamine, trimethylene dimelamine, tetramethylene dimelamine, hexamethylene dimelamine, decamethylene dimelamine, dodecamethylene dimelamine, 1,3-cyclohexylene dimelamine, p-phenylene dimelamine, p-xylylene dimelamine, 4,4-dityrene dimelamine, diethylene trimelamine, triethylene tetramelamine, tetraethylene pentamelamine, and hexaethylene heptamelamine.

5. The method as defined in claim 1, 2 or 4, wherein the reaction represented by the Reaction Scheme 2 is performed in the presence of water or an organic solvent at 10-190° C.

6. A dicyclic phosphorus-melamine compound having excellent flame retardancy prepared according to any one of claims 1 to 5, represented by the following formula 1:

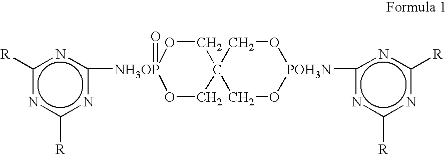

7. A flame retardant for use with a polymer using the dicyclic phosphorus-melamine compound of claim 6, the polymer being selected from the group consisting of polystyrene, polyethylene, terephthalate, polybutylene terephthalate, polypropylene, polyisobutylene, EPDM polymer, polyisoprene, ABS polymer, MBS polymer poly(acrylate), poly(methylmethacrylate), poly(vinylacetate), polyvinyl chloride, and combinations thereof.
